(19) United States
(12) Patent Application Publication
(10) Pub. No.: US 2021/0386178 A1
(43) Pub. Date: Dec. 16, 2021

(54) STORAGE MEDIUM, COMPUTER CONTROL METHOD, AND INFORMATION PROCESSING APPARATUS

(71) Applicant: CANON KABUSHIKI KAISHA, Tokyo (JP)

(72) Inventor: Yuuki Wakabayashi, Kanagawa (JP)

(21) Appl. No.: 17/338,781

(22) Filed: Jun. 4, 2021

(30) Foreign Application Priority Data
Jun. 12, 2020 (JP) 2020-102185

(51) Int. Cl. A45D 29/00; G06F 3/0488

(52) U.S. Cl. CPC A45D 29/001; A45D 2029/005; G06F 3/0488

(57) ABSTRACT

An object of the present disclosure is to improve operability of a user in printing of contents data. One embodiment of the present invention is a non-transitory computer-readable storage medium storing a program for causing a computer to operate as a display control unit configured to cause a display unit to display a graphical user interface having a first area for designating one contents image from among a plurality of contents images configuring a contents image group, a second area for designating one contents image group from among a plurality of contents image groups, a third area for designating an individual reflection target reflecting a contents image, and a fourth area for designating one reflection target group including a plurality of individual reflection targets.

### BACKGROUND OF THE INVENTION

### Field of the Invention

The present disclosure relates to a technique to lay out contents.

### Description of the Related Art

In recent years, it has been made possible to print a nail art on a fingernail by using a printer. In the following, a printer for printing a nail design for a nail art on a fingernail is referred to as a nail printer.

Japanese Patent Laid-Open No. 2013-63282 has described a technique to display an image of a selected nail design on the printing-target fingers, that is, the index finger, the middle finger, the third finger, and the little finger, respectively, in an overlapping manner.

### SUMMARY OF THE INVENTION

However, the more improvement of the operability of a user in printing of contents data has been demanded.

One embodiment of the present invention is a non-transitory computer-readable storage medium storing a program for causing a computer to operate as: a display control unit configured to cause a display unit to display a graphical user interface having a first area for designating one contents image from among a plurality of contents images configuring a contents image group, a second area for designating one contents image group from among a plurality of contents image groups, a third area for designating an individual reflection target reflecting a contents image, and a fourth area for designating one reflection target group including a plurality of individual reflection targets; and a reflection unit configured to, in a case where the first area and the third area are designated by a user, reflect a contents image corresponding to the first area in a reflection target corresponding to the third area and in a case where the second area and the fourth area are designated by a user, reflect each of plurality of contents images configuring the contents image group corresponding to the second area in each of a plurality of individual reflection targets configuring a reflection target group corresponding to the fourth area in accordance with correspondence information indicating correspondence between each of the plurality of contents images and each of the plurality of individual reflection targets.

Further features of the present invention will become apparent from the following description of exemplary embodiments with reference to the attached drawings.

### BRIEF DESCRIPTION OF THE DRAWINGS

FIG. 1A and FIG. 1B are diagrams showing a configuration of a system in a first embodiment;

FIG. 2 is a diagram explaining a first GUI screen;

FIG. 3A to FIG. 3C are each a diagram explaining a second GUI screen;

FIG. 4A to FIG. 4C are each a diagram explaining an example in which a fingernail preview is designated after designating nail image data;

FIG. 5A to FIG. 5C are each a diagram explaining an example in which a hand preview is designated after designating nail image data;

FIG. 6A to FIG. 6C are each a diagram explaining an example in which nail image data is designated after designating a fingernail preview;

FIG. 7A to FIG. 7C are each a diagram explaining an example in which nail art data is designated after designating a fingernail preview;

FIG. 8A to FIG. 8D are each a diagram explaining an example in which a preview of only one hand is displayed;

FIG. 9 is a diagram showing a print data creation screen; and

FIG. 10 is a flowchart of information processing in the first embodiment.

### DESCRIPTION OF THE EMBODIMENTS

In the following, embodiments of the present disclosure are explained in detail. The following embodiments are illustrations for explaining the present disclosure and not intended to limit the present disclosure only to those embodiments. Further, it is possible to modify the present disclosure in a variety of manners as long as the modification does not depart from the gist thereof.

### First Embodiment

### <System Configuration>

A system in the present embodiment has an information processing apparatus and a printer. In the present embodiment, explanation is given by taking a tablet terminal as an example of the information processing apparatus. However, the information processing apparatus is not limited to the tablet terminal. As the information processing apparatus, it is possible to adopt various items, such as a mobile terminal, a note PC, a smartphone, a PDA (Personal Digital Assistant), and a digital camera.

Further, as the printer in the present embodiment, it is possible to adopt, for example, an ink jet printer, a monochrome printer, a 3D printer and the like. However, the printer of the present embodiment may be a multifunction printer comprising a plurality of functions, such as the copy function, the FAX function, and the print function. The printer of the present embodiment has a function of performing drawing directly on a fingernail of a human hand. In the present embodiment, explanation is given by distinguishing the information processing apparatus and the printer as separate apparatuses, but an aspect may be accepted in which an apparatus having the functions of both apparatuses in an integrated manner is used.

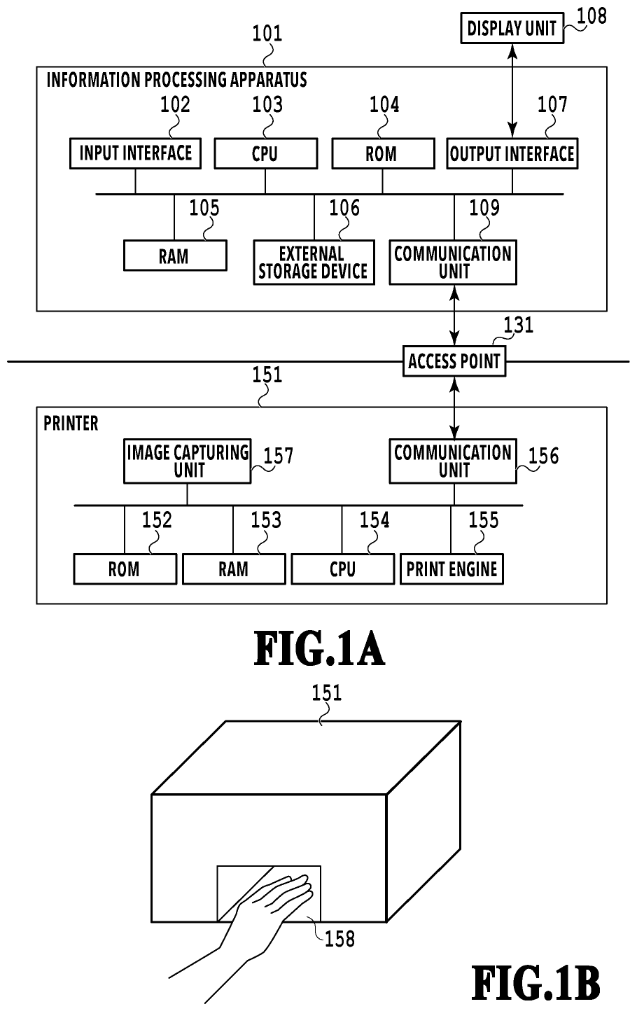

FIG. 1A and FIG. 1B are diagrams explaining the system having an information processing apparatus 101 and a printer 151 of the present embodiment. FIG. 1A is a block diagram of the system having the information processing apparatus 101 and the printer 151. FIG. 1B is a schematic diagram of an outer appearance of the printer 151. In the following, by using FIG. 1A and FIG. 1B, the configuration of the information processing apparatus 101 and the printer 151 is explained.

### <Information Processing Apparatus>

As shown in FIG. 1A, the information processing apparatus 101 has an input interface 102, a CPU 103, a ROM 104, a RAM 105, an external storage device 106, an output interface 107, and a communication unit 109. These are connected to one another via a system bus.

The input interface 102 is an interface for receiving a data input and operation instructions from a user via an operation unit (not shown schematically) including a physical keyboard, buttons, a touch panel and the like. The aspect of the information processing apparatus 101 in the present embodiment is such that a display unit 108, to be described later, and at least part of the operation unit are integrated into one unit and for example, the output of a screen and the reception of an operation from a user are performed on the same screen.

The CPU 103 is a system control unit and controls the entire information processing apparatus 101 by executing programs and activating hardware. In the ROM 104, control programs executed by the CPU 103, data tables, a built-in operating system (in the following, referred to as OS), and data of programs and the like are stored. In the present embodiment, each control program stored in the ROM 104 performs software execution control, for example, such as scheduling, task switch, and interrupt processing, under the management of the built-in OS stored in the ROM 104.

The RAM 105 includes an SRAM (Static Random Access Memory), a DRAM or the like. In the RAM 105, data may be stored by a primary battery for data backup, not shown schematically. In that case, it is possible to store data of program control variables and the like in the RAM 105 without volatilizing the data. Further, in the RAM 105, a memory area is also provided, which stores setting information on the information processing apparatus 101, management data on the information processing apparatus 101, and the like. Furthermore, the RAM 105 is also used as a main memory and a work memory of the CPU 103.

In the external storage device 106, an application that provides a printing execution function, a printing information generation program that generates a print job that the printer 151 can interpret, and the like are stored. Further, in the external storage device 106, various programs, such as an information transmission and reception control program that performs transmission and reception of information with the printer 151 connected via the communication unit 109, and various kinds of information that these programs use, and the like are stored.

The output interface 107 is an interface that performs control of the display of data by the display unit 108, the notification of the state of the information processing apparatus 101, and the like.

The display unit 108 has an LED (Light-Emitting Diode), an LCD (Liquid Crystal Display) or the like and performs the display of data, the notification of the state of the information processing apparatus 101, and the like. It may also be possible to receive an input from a user via the display unit 108 by installing a soft keyboard including keys, such as a numerical value input key, a mode setting key, a determination key, a cancellation key, and a power source key, on the display unit 108. Further, the display unit 108 may be configured as a touch panel display. The display unit 108 is connected with the system bus of the information processing apparatus 101 through the output interface 107.

The communication unit 109 is configured so as to perform data communication by connecting to an external device, such as the printer 151. It is possible for the communication unit 109 to connect to an access point (not shown schematically) within the printer 151. That is, in the present embodiment, it is possible for a communication unit 156 within the printer 151 to operate as an access point. The access point is an example and what is required is that the communication unit 156 operate as a master station at the time of performing wireless communication in conformity to the IEEE 802.11 series, and for example, the communication unit 156 may operate as a group owner of Wi-Fi Direct. By the communication unit 109 connecting to the access point within the printer, it is made possible for the information processing apparatus 101 and the printer 151 to perform direct wireless communication with each other. It may also be possible for the communication unit 109 to perform direct communication with the printer 151 by using wireless communication or to communicate with the printer 151 via an external access point (access point 131) existing outside. As the wireless communication method, for example, Bluetooth (registered trademark) or the like may be used, not limited to Wi-Fi (Wireless Fidelity) (registered trademark). As the external access point 131, mention is made of, for example, a device such as a wireless LAN router. In the present embodiment, the method in which the information processing apparatus 101 and the printer 151 connect directly to each other without the intervention of the external access point 131 is called the direct connection method. Further, the method in which the information processing apparatus 101 and the printer 151 connect to each other via the external access point 131 is called the infrastructure connection method. The aspect may also be one in which the information processing apparatus 101 and the printer 151 are connected via a wire.

In the present embodiment, it is assumed that the information processing apparatus 101 stores a predetermined application in the ROM 104, the external storage device 106 or the like. The predetermined application is an application program for transmitting a print job for printing nail art data to the printer 151 in response to, for example, the operation from a user. The application that has the function such as this is called a nail application hereinafter. The nail application may have another function in addition to the print function. For example, the nail application in the present embodiment may have a function to activate a camera of an image capturing unit 157 of the printer 151 by communicating with the printer 151. That is, the nail application may have a function to transmit a camera activation job to the printer 151 other than the print job. Further, the predetermined application stored in the ROM 104, the external storage device 106 or the like is not limited to the nail application and may be an application program having a function other than printing.

### <Printer>

The printer 151 has a ROM 152, a RAM 153, a CPU 154, a print engine 155, the communication unit 156, and the image capturing unit 157. These components are connected to one another via a system bus. Further, the printer 151 has a printing-target insertion unit 158 that is a space for inserting a printing target. FIG. 1B is a schematic diagram showing the outer appearance of the printer 151. As shown in FIG. 1B, inside the printer 151, the printing-target insertion unit 158 is provided. FIG. 1B shows the way a user inserts his/her right hand into the printing-target insertion unit 158. As described above, in the present embodiment, it is supposed that a human hand is inserted into the printing-target insertion unit 158 and it is supposed that the printing target is a fingernail.

In the ROM 152, control programs executed by the CPU 154, a data table, and data of the OS program and the like are stored. In the present embodiment, each control program stored in the ROM 152 performs software execution control, such as scheduling, task switch, and interrupt processing, under the management of the built-in OS stored in the ROM 152.

The RAM 153 includes an SRAM, a DRAM or the like. In the RAM 153, data may be stored by a primary battery for data backup, not shown schematically. In this case, it is possible to store data of program control variables and the like in the RAM 153 without volatilizing the data. Further, a memory area that stores setting information on the printer 151, management data on the printer 151, and the like is also provided in the RAM 153. Furthermore, the RAM 153 is also used as a main memory and a work memory of the CPU 154 and it is possible for the RAM 153 to temporarily store printing information received from the information processing apparatus 101 and various kinds of information and the like.

The CPU 154 is a system control unit and controls the entire printer 151 by executing programs and activating hardware. The print engine 155 forms an image on a printing-target medium, such as a fingernail, which is inserted into the printing-target insertion unit 158 by using a printing material, such as ink, based on the information stored in the RAM 153 or the print job received from the information processing apparatus 101.

It is possible for the communication unit 156 to operate as an access point for performing wireless communication by the direct connection method with an external apparatus, such as the information processing apparatus 101. In the present embodiment, it is possible for the communication unit 156 that operates as this access point to connect to the communication unit 109 of the information processing apparatus 101. It may also be possible for the communication unit 156 to directly communicate with the information processing apparatus 101 by using wireless communication or communicate with the information processing apparatus 101 via the external access point 131. In a case where the communication unit 156 connects with the external access point 131 in the infrastructure connection method, the communication unit 156 operates as a slave station and the external access point 131 operates as a master station. Further, the communication unit 156 may have hardware that functions as an access point or the communication unit 156 may operate as an access point by software for causing the communication unit 156 to function as an access point.

The image capturing unit 157 is a device having an image capturing function and belongs to the printer 151 and is arranged therein. The image capturing unit 157 has a function to capture a predetermined area including a printing target (specifically, fingernail) that is inserted into the printing-target insertion unit 158 and send the captured image (still image or moving image) to the information processing apparatus 101 real time. In the present embodiment, the image capturing unit 157 captures a moving image and is a camera module having at least a lens and an image sensor. The lens collects light rays from the printing target that is inserted into the printing-target insertion unit 158 and forms an image on the image sensor. The image sensor converts the light rays collected by the lens into an electrical signal that the CPU 154 can process. It may also be possible to use a smartphone, a mobile terminal, a digital camera or the like in place of the camera module as a device having the image capturing function in a case where the device has the function such as this. The print engine 155 performs printing for the printing target that is inserted into the printing-target insertion unit 158.

It may also be possible to attach a memory, such as an external HDD and a SD card, to the printer 151 and the information stored in the printer 151 may be stored in the memory. Further, the configuration shown in FIG. 1A and FIG. 1B is merely exemplary and each of the information processing apparatus 101 and the printer 151 may have components other than those described previously, but explanation thereof is omitted here.

### Definition of Terms

Next, terms that are used in the present embodiment are explained. The present embodiment is an aspect in which a nail art is printed mainly on a fingernail. Further, the aspect shown in FIG. 1B is an aspect in which a nail art is printed on each fingernail of one hand. In general, the nail art that is printed on each fingernail has the same concept, but there is a case where the nail art that is printed on each individual fingernail is not exactly the same nail art. For example, in a nail art set of design A, ten nail arts (corresponding to each fingernail of five fingers of each of both hands) are included and the ten nail arts have the common design concept, but there is a case where the patterns are not exactly the same. In view of the above-described points, in the present embodiment, terms are defined as follows.
“nail image data”: refers to image data of a nail art that is printed on one fingernail.
“nail art data”: refers to an aggregate of a plurality of pieces of nail image data. That is, the nail art data can also be said as a data set of a plurality of pieces of nail image data. Typically, the nail art data is image data aggregating images of each piece of nail image data corresponding to the nail arts of ten fingernails. The nail art data may be data aggregating each of ten pieces of nail image data (that is, a set of ten pieces of image data) or may be image data obtained by combining each of ten pieces of nail image data into one image. Alternatively, the nail art data may be a data set of five representative pieces of nail image data among the ten pieces of nail image data by taking into consideration the display area of the nail art data, to be described later.

As described above, it is assumed that in a case where “nail image data” is referred to, the data of the image of the nail art of each individual fingernail is referred to, and in a case where “nail art data” is referred to, a data set of images of a plurality of nail arts is referred to.

### <Outline of Printing of Nail Art>

In the present embodiment, the nail application is activated by the CPU 103 of the information processing apparatus 101 executing the program of the nail application stored in the ROM 104 or the external storage device 106. Then, by using the nail application, it is possible for a user to print a nail art on a fingernail by reflecting the nail image data selected by the user in the printing area. That is, the following series of operations is performed by using the nail application. (1) A user selects nail image data that is printed on one or a plurality of fingernails on the application. (2) A user inserts his/her hand into the nail printer. (3) The hand inserted by a user is captured by a camera within the nail printer. (4) The application produces a display based on the captured image data transmitted from the nail printer. (5) On the displayed captured image, a user sets the area of the fingernail on which printing is desired to be performed as the printing area of the nail art. (6) The application reflects the nail image data selected in (1) in the printing area set by a user. For example, the application displays the nail image data in the printing area set by a user in an overlapping manner. (7) The application causes the printer 151 to perform printing using the reflected nail image data.

In the following, an aspect is explained in which it is possible for a user to easily select nail image data desired to be printed on one or each of a plurality of fingernails in the process of (1) described above. A user who inserts his/her hand into the printer 151 and a user who operates the application may be the same user or different users. In the present embodiment, explanation is given by taking a nail printer as an example that enables printing up to four fingernails at a time.

### <Graphical User Interface of Nail Application>

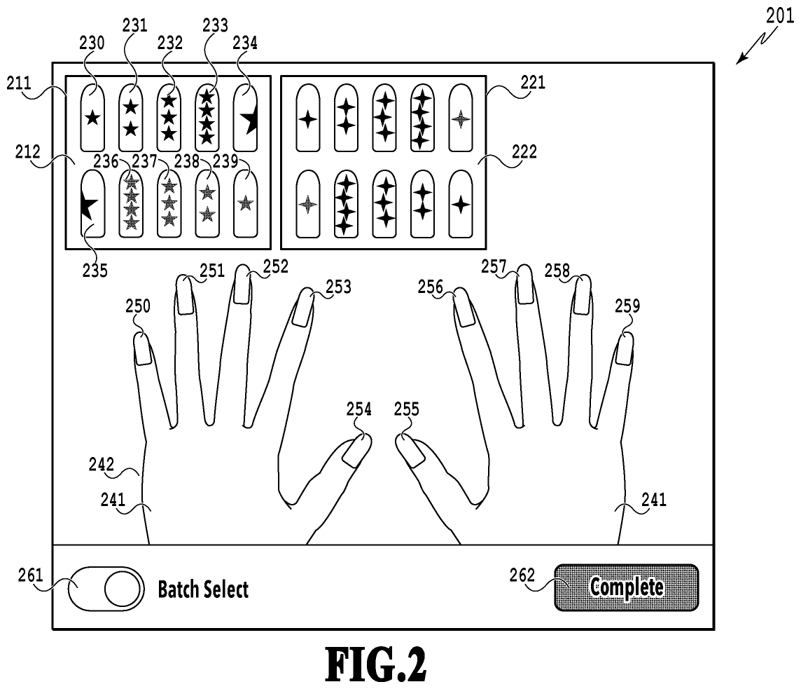

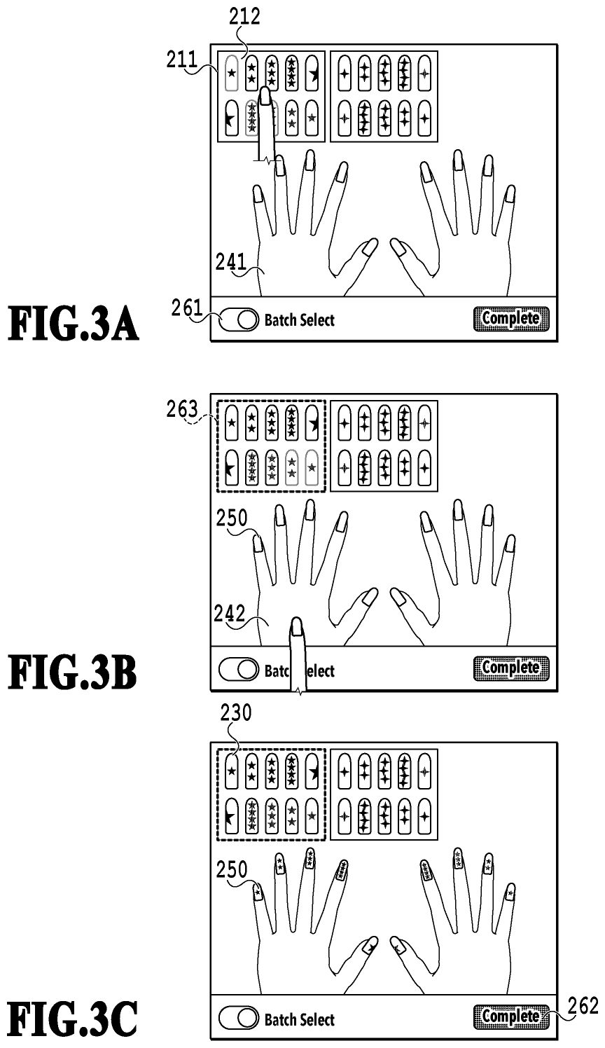

In order to make understanding easy, a graphical user interface (in the following, described as GUI) screen that is displayed in the nail application is explained first. The GUI screen that is explained in the following is displayed on the display unit 108 by the CPU 103 that executes the nail application. Further, explanation is given on the assumption that the input interface 102 functions as the operation unit integrated with the display unit 108 into one unit. The GUI screen of the nail application in the present embodiment is roughly divided into two kinds. A first GUI screen is a selection screen of nail image data, which is shown in FIG. 2. A second GUI screen is a screen for creating print data shown in FIG. 3A to FIG. 3C. In the following, by using FIG. 2 to FIG. 3C, the GUI screen of the nail application is explained.

FIG. 2 shows a nail image data selection screen 201 as the first GUI screen in the present embodiment. On the nail image data selection screen 201, first nail art data 211 and second nail art data 221 are displayed. In the present embodiment, the two kinds of nail art data are displayed as described above, but the number of pieces of nail art data that is displayed may be one, three, or four or more.

The area including all the nail image data included in the first nail art data 211 is taken as a first nail art data area 212 and the area including all the nail image data included in the second nail art data 221 is taken as a second nail art data area 222. Each piece of nail image data for each finger, which is displayed within the nail art data area, is displayed at a position defined in advance for each finger. The nail art data area including each area of the plurality of pieces of individual nail image data is also called a contents image group selection area.

In the following, the nail image data that is displayed within the first nail art data area 212 is explained. In order from the leftmost data in the upper row, the image data is nail image data 230 for the left hand little finger, nail image data 231 for the left hand third finger, nail image data 232 for the left hand middle finger, nail image data 233 for the left hand index finger, and nail image data 234 for the left hand thumb. Following the above, in order from the leftmost data in the lower row, the image data is nail image data 235 for the right hand thumb, nail image data 236 for the right hand index finger, nail image data 237 for the right hand middle finger, nail image data 238 for the right hand third finger, and nail image data 239 for the right hand little finger. That is, the nail application stores correspondence information bringing each piece of the nail image data included in the nail art data into correspondence with each fingernail preview area. This correspondence information is created at the point in time at which the nail art data is created. The arrangement of the nail image data explained here is an example and it may also be possible to adopt arrangement other than that described here.

On the nail image data selection screen 201, a hand preview 241 is displayed so that it is possible for a user to check the preview in which the selected nail image data is reflected on each fingernail of each finger. The hand preview 241 is supposed to be an image prepared in advance, but the hand preview 241 may be, for example, an image captured in a case where a user inserts his/her hand into the printing-target insertion unit 158 of the printer 151. Further, on the nail image data selection screen 201, a hand preview area 242 for enabling a user to select the hand preview 241 exists. The hand preview area 242 including a plurality of individual reflection targets (area of the fingernail of each finger) is also called a reflection target group selection area.

The hand preview area 242 may be a range that overlaps the hand preview 241 or may be an area slightly larger than the hand preview 241 in order to improve the easiness of selection as in the present embodiment. It may of course be possible to display a frame that surrounds the hand preview explicitly and take the inside of the frame as the hand preview area 242. In the hand preview 241, the preview area of the fingernail of each finger is included. Specifically, in order from the leftmost area of the hand preview 241, the area is a fingernail preview area 250 of the left hand little finger, a fingernail preview area 251 of the left hand third finger, a fingernail preview area 252 of the left hand middle finger, a fingernail preview area 253 of the left hand index finger, and a fingernail preview area 254 of the left hand thumb. Further, following the above, the area is a fingernail preview area 255 of the right hand thumb, a fingernail preview area 256 of the right hand index finger, a fingernail preview area 257 of the right hand middle finger, a fingernail preview area 258 of the right hand third finger, and a fingernail preview area 259 of the right hand little finger.

As the hand preview 241, it may also be possible to display both hands by giving importance to at-a-glance visibility or display a partially enlarged portion of the hand by giving importance to visual recognizability in a case where the nail image data is reflected. That is, for example, it may also be possible to display only the little finger, the third finger, the middle finger, and the index finger of the left hand, or display only the thumb of the right hand.

FIG. 3A to FIG. 3C show a flow of reflecting the nail art data in the hand preview at a time. In a case where a user desires to reflect all the nail image data included in the first nail art data 211 in the hand preview 241 as a printing target, the user designates the first nail art data area 212 as shown in FIG. 3A. At this time, as shown in FIG. 3A, in order to designate the first nail art data area 212, a user designates a position that does not overlap the nail image data 230 to 239 of each finger displayed on the first nail art data area 212. As another embodiment for a user to designate the first nail art data area 212, it may also be possible to make a Batch Select switch 261 effective. In the state where the Batch Select switch 261 is effective, even in a case where a user designates a position that overlaps the nail image data 230 to 239 of each finger displayed on the first nail art data area 212, the first nail art data 211 is regarded as having been designated. In a case where the first nail art data area 212 is designated, as shown in FIG. 3B, a display frame 263 indicating that the state is where the nail art data is selected is displayed so that it is possible to visually recognize that the first nail art data 211 has been selected. In the present embodiment, the display frame 263 is displayed so that it is possible to visually recognize that the first nail art data 211 has been selected, but another aspect may be accepted. For example, an aspect may be accepted in which an icon indicating that the nail art data has been selected is displayed temporarily on the first nail art data 211. The aspect is not limited as long as it is possible to cause a user to recognize that the nail art data has been selected. Further, in the present embodiment, explanation is given on the assumption that the Batch Select switch 261 is made ineffective.

In a case where a user designates the hand preview area 242 in the state where the first nail art data 211 is selected, as shown in FIG. 3C, the first nail art data 211 is reflected in the fingernail preview areas 250 to 259 of each finger included in the hand preview 241. That is, the nail image data 230 to 293 corresponding to each finger are reflected in each corresponding fingernail preview area of each finger at a time. For example, the nail image data 230 of the left hand little finger is reflected in the corresponding fingernail preview area 250 of the left hand little finger. For the other fingers, the nail image data is reflected similarly. The hand preview area 242 includes the fingernail preview areas 250 to 259 of each finger, but in the state where the nail art data is selected, even in a case where one of the fingernail preview areas 250 to 259 of each finger is designated, this is handled as that the hand preview area 242 is designated. That is, the nail application reflects the corresponding nail art image of each finger for the fingers of all the displayed fingernail previews. For example, in the state where the nail art data is selected shown in FIG. 3B, even in a case where the fingernail preview area 250 of the left hand little finger is designated, as in the case where the hand preview are 242 is designated, the state shown in FIG. 3C is brought about.

In the embodiment described previously, the nail art data is reflected by designating the hand preview area 242 after designating the first nail art data area 212, but the aspect of reflecting the nail art data is not limited to this. In order to reduce one user operation, it may also be possible to reflect the nail art data at the point in time at which the first nail art data area 212 is designated. However, in that case, it is preferable to prevent the work having been done so far from becoming ineffective by an erroneous operation of touch For example, in a case where even one piece of the nail image data is not reflected in the fingernail preview areas of all the fingers, the nail art data is reflected without causing a user to designate the hand preview area 242. On the contrary, in a case where at least one piece of the nail image data is reflected in the fingernail preview area, the nail art data is not reflected, or it may also be possible to make an inquiry to a user about whether to permit the reflection of the nail art data.

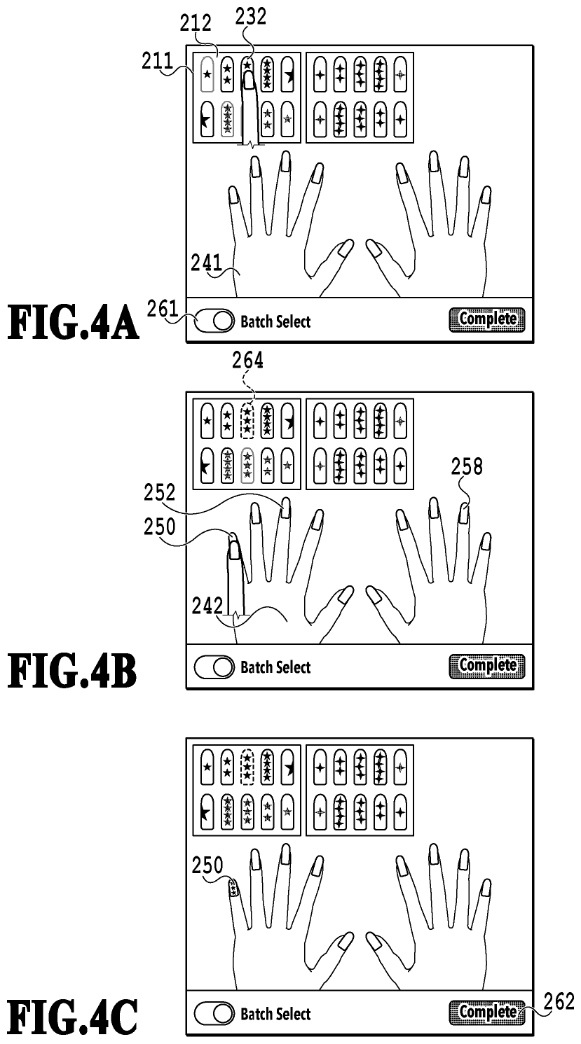

FIG. 4A to FIG. 4C show an example of a flow of reflecting one piece of nail image data within the nail art data in the hand preview. In a case where a user desires to reflect the nail image data 232 of the left hand middle finger within the first nail art data 211 in the fingernail preview area 250 of the left hand little finger, as shown in FIG. 4A, the user designates the nail image data 232 of the left hand middle finger. In a case where the nail image data 232 is designated, as shown in FIG. 4B, a display frame 264 indicating that the state is where the nail image data is selected is displayed so that it is possible to visually recognize that the nail image data 232 of the left hand middle finger has been selected. As regards the method of causing a user to recognize that the nail image data has been selected, like the display frame described previously that is displayed in a case where the nail art data is selected, the aspect is not limited to that in FIG. 4B as long as it is possible to cause a user to recognize that and any aspect may be adopted. In a case where a user designates the fingernail preview area 250 of the left hand little finger in the state where the nail image data 232 of the left hand middle finger is selected, as shown in FIG. 4C, the nail image data 232 of the left hand middle finger is reflected in the fingernail preview area 250 of the left hand little finger. As another example, in a case where a user desires to reflect the nail image data 232 of the left hand middle finger in the fingernail preview area 258 of the right hand third finger in place of the left hand little finger, the nail image data 232 of the left hand middle finger is reflected in the fingernail preview area 258 of the right hand third finger by designating the fingernail preview area 258 of the right hand third finger in the state where the nail image data 232 of the left hand middle finger is selected.

In the aspect described previously, the nail image data is reflected by designating the fingernail preview area 250 after designating the nail image data 232 in FIG. 4A, but the aspect of reflecting the nail image data is not limited to this. In order to reduce one user operation, it may also be possible to reflect the nail image data in the fingernail preview area 252 of the left hand middle finger at the point in time at which the nail image data 232 of the left hand middle finger is designated. In that case, on a condition that a user desires to reflect the nail image data in the fingernail preview area 252 of the left hand middle finger, it is sufficient to leave it as it is. On the other hand, in a case where a user desires to reflect the nail image data in the fingernail preview area of another finger, it is sufficient to designate, for example, the fingernail preview area 250 of the left hand little finger in the state where the nail image data 232 is reflected in the fingernail preview area 252 of the middle finger. By doing so, as shown in FIG. 4C, the nail image data is reflected in the fingernail preview area designated later. At that time, the reflection of the nail image data in the fingernail preview area of the left hand middle finger, which is reflected without designation, is cancelled. Of course, it may also be possible to make an inquiry to a user about whether to permit the cancellation before cancelling the reflection although the time and effort of a user increases.

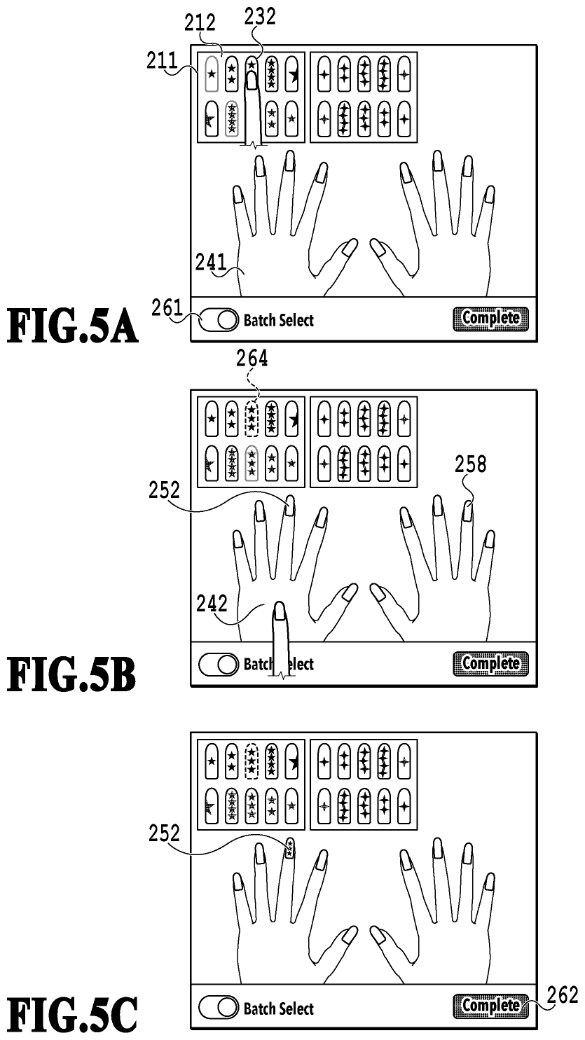

FIG. 5A to FIG. 5C each show another example of a flow of reflecting one piece of nail image data within the nail art data in the hand preview. In a case where a user desires to reflect the nail image data 232 of the left hand middle finger within the first nail art data 211 in the fingernail preview area 252 of the left hand middle finger as it is, first, the user designates the nail image data 232 of the left hand middle finger as shown in FIG. 5A. Next, it is possible to reflect the nail image data 232 by designating the fingernail preview area 252 of the left hand middle finger as described previously, but here, the user designates the hand preview area 242 as shown in FIG. 5B. In a case where an area that does not overlap the fingernail preview area in the hand preview area 242 is designated in the state where the nail image data 232 is designated, as shown in FIG. 5C, the nail image data is reflected in the fingernail preview area of the finger corresponding to the finger of the designated nail image data. That is, the nail art of the left hand middle finger is reflected on the left hand middle finger. Further, in a case where the nail image data is selected after selecting the hand preview area 242 in FIG. 5A to FIG. 5C, the nail image data is reflected in the fingernail preview area corresponding to the selected nail image data. For example, in a case where the nail image data 232 is designated as in FIG. 5A after selecting the hand preview area 242, the nail image data 232 is reflected in the fingernail preview area 252 that is the fingernail of the left hand middle finger brought into correspondence with the nail image data 232.

On the other hand, in a case where the fingernail preview area is designated in the state where the nail image data 232 is designated, the nail image data 232 is reflected in the designated fingernail preview area. For example, in a case where the fingernail preview area 258 is designated in the state where the nail image data 232 is designated as in FIG. 5A, the nail image data 232 is reflected in the fingernail preview area 258 of the right hand third finger.

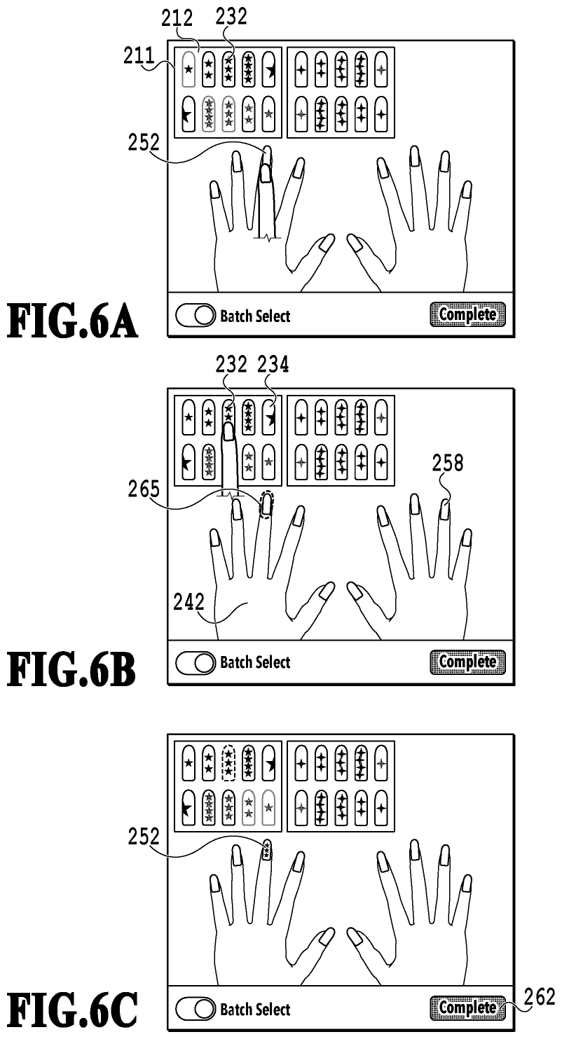

In FIG. 3A to FIG. 5C, the embodiment is shown in which a user designates the hand preview or the fingernail preview in which nail art data or nail image data is reflected after designating the nail art data or the nail image data. As another embodiment, it may also be possible to designate nail art data or nail image data after designating the hand preview or the fingernail preview in which the nail art data or the nail image data is desired to be reflected. A specific flow is explained by using FIG. 6A to FIG. 6C. In a case where the nail image data 232 of the left hand middle finger within the first nail art data 211 is reflected in the fingernail preview area 252 of the left hand middle finger, first, the fingernail preview area 252 of the left hand middle finger is designated as shown in FIG. 6A. Due to this, as shown in FIG. 6B, a display frame 265 indicating that the state is where the fingernail preview is selected is displayed. In a case where a user designates the nail image data 232 in the state where the display frame 265 is displayed as shown in FIG. 6B, the nail image data 232 is reflected in the fingernail preview area 252 of the left hand middle finger as shown in FIG. 6C. Here, the aspect is explained in which the nail image data 232 of the left hand middle finger is designated in FIG. 6B, but another embodiment is also considered. For example, as another embodiment, in a case where the nail image data 234 of the left hand thumb is designated, of course, the nail image data 234 of the left hand thumb is reflected in the fingernail preview area 252 of the left hand middle finger.

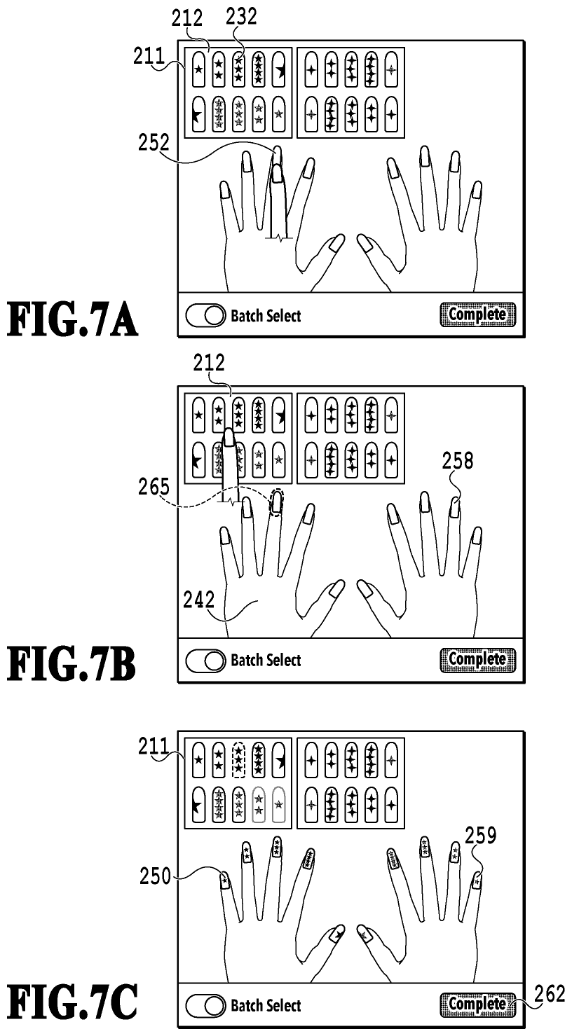

In FIG. 6A to FIG. 6C, the nail image data is designated after designating the fingernail preview area, but FIG. 7A to FIG. 7C each show a flow in a case where an area that does not overlap the nail image data area within the first nail art data area 212 is designated after designating the fingernail preview area as another embodiment. First, as shown in FIG. 7A, a user designates the fingernail preview area 252 of the left hand middle finger. Due to this, as shown in FIG. 7B, the display frame 265 indicating that the state is where the finger preview is selected is displayed. Next, a user designates an area that does not overlap the nail image data in the first nail art data area 212. By this designation, the CPU 103 determines that the user desires to reflect the nail art data and reflects the first nail art data 211 in the preview areas 250 to 259 of each fingernail as shown in FIG. 7C. This determination is effective in a case where there is room in the designation area of the nail art data. As another embodiment, in a case where there is no room in the designation area of the nail art data, it may happen sometimes that a user designates the nail art data area although the user tries to designate the nail image data. In that case, it may also be possible to reflect the nail image data closest from the position on the designated nail art data area or ignore the designation to that the user can easily designate again. Alternatively, it may also be possible for the nail application to make an inquiry to a user about whether to select the closest nail image data or select the nail art data by displaying a check screen. In a case where the designation is ignored, on a condition that the re-designation of the nail image data succeeds, the nail image data is reflected in the fingernail preview area. That is, it may be possible to freely determine the determination method in a case where a user designates an area that does not overlap the nail image data within the nail art data area depending on the size of the display area or the layout of the nail image data of each finger within the nail art data area.

Designation may be made by another method. For example, the fingernail preview area may be designated after the nail art data is designated. In this case, the nail image data corresponding to the fingernail preview area designated in the nail image data included in the nail art data is reflected in the fingernail preview area. For example, in a case where the fingernail preview area 258 is selected after selecting the nail art data, the nail image data brought into correspondence with the right hand third finger included in the nail art data is reflected in the fingernail preview area 258.

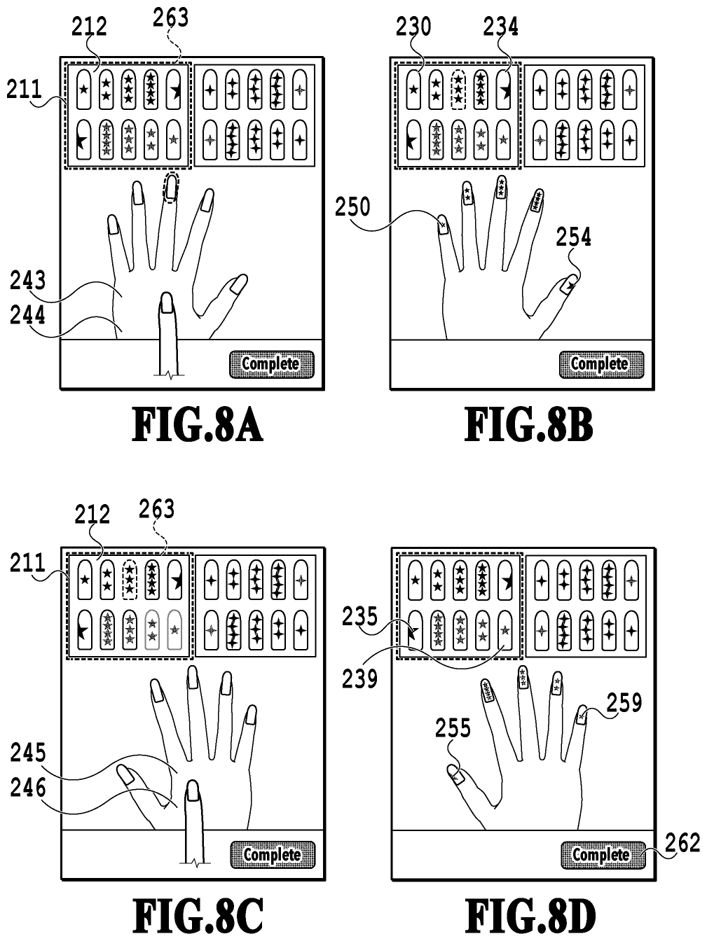

In FIG. 3A to FIG. 7C, both hands, that is, the left and the right hand are displayed as the hand preview, but FIG. 8A to FIG. 8D each show a flow in a case where it is not possible to display a preview of both hands because the display area is narrow. FIG. 8A shows the state where the first nail art data area 212 is designated and the display frame 263 is displayed in a case where it is possible to display only a left hand preview 243. In a case where a left hand preview area 244 is designated in that state, as shown in FIG. 8B, for the fingernail preview areas 250 to 254 of each finger of the left hand, the nail image data 230 to 234 corresponding to each finger of the left hand within the nail art data are reflected. At this time, which nail image data is reflected in the fingernail preview of which finger is defined in advance.

Next, FIG. 8C shows the state where the first nail art data area 212 is designated and the display frame 263 is displayed in a case where it is possible to display only a right hand preview 245. In a case where a right hand preview area 246 is designated in that state, as shown in FIG. 8D, for the fingernail preview areas 255 to 259 of each finger of the right hand, the nail image data 235 to 239 corresponding to each finger of the right hand within the nail art data are reflected. At this time also, as in the case of the left hand, which nail image data is reflected in the fingernail preview of which finger is defined in advance. In FIG. 8A to FIG. 8D, explanation is given by taking the state as an example where it is possible to display only the left hand or the right hand. As another example, for example, even in the state where it is possible to display only the left hand thumb or the like, in a case where the correspondence between the finger of the nail art data and the fingernail preview of the finger is defined in advance, it is possible to apply the present embodiment. Further, as another example, even in the state where, for example, a total of the eight fingers except for each thumb of both hands are displayed, it is possible to apply the present embodiment.

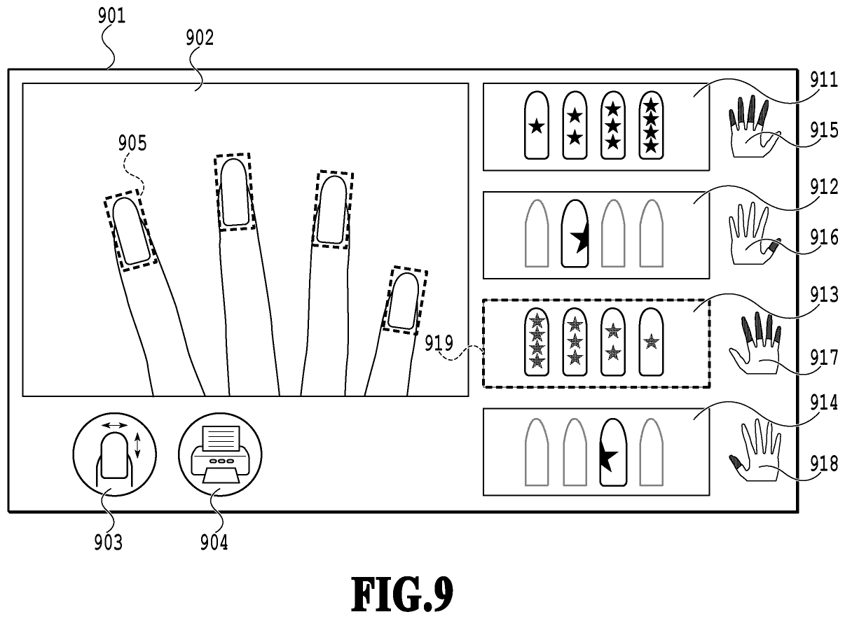

In a case where a Complete button 262 is pressed down after which nail image data is reflected on the fingernail of which finger is determined by the embodiments illustrated in FIG. 3A to FIG. 8D, the screen transitions to a print data creation screen 901 as shown in FIG. 9.

FIG. 9 is a diagram showing the print data creation screen 901 as the second GUI screen for creating print data. The print data creation screen 901 has a captured image display area 902, a fingernail recognition button 903, and a printing execution button 904. Further, the print data creation screen 901 has a nail image data display area 911 of four fingers of the left hand, an icon 915 indicating which finger corresponds to each of these fingers, a nail image data display area 912 of one finger of the left hand, and an icon 916 indicating which finger corresponds to this finger. Furthermore, the print data creation screen 901 has a nail image data display area 913 of four fingers of the right hand, an icon 917 indicating which finger corresponds to each of these fingers, a nail image data display area 914 of one finger of the right hand, and an icon 918 indicating which finger corresponds to this finger.

In the nail image data display areas 911 to 914 of the fingers, the nail image data of each finger selected on the first GUI screen is displayed and the fingernail of which finger is printed at which position in the nail printer of the present embodiment capable of performing printing for up to four fingers at a time is indicated. For example, in the nail image data display area 911 of four fingers of the left hand, as the nail image data selected on the first GUI screen, the nail image data of the little finger, the third finger, the middle finger, and the index finger of the left hand in order from the left is displayed and which finger is to be placed at which position of the nail printer is indicated. Which finger each of the fingers displayed in the nail image data display area 911 corresponds to is indicated by the icon 915 and it is made possible to visually understand this. Similarly, in the nail image data display area 912 of one finger of the left hand, at the second position from the left, as the nail image data selected on the first GUI screen, the nail image data of the thumb of the left hand is displayed. This indicates that it is sufficient to place the thumb of the left hand at the second printing position from the left of the four printing positions in the nail printer. That the displayed nail image data is the data of the thumb of the left hand can be recognized by the icon 916. Similarly, for four fingers of the right hand and one finger of the right hand, the same as described above is indicated by the nail image data display areas 913 and 914 and the icons 917 and 918.

In the following, an example of the processing up to the actual printing on the fingernail is shown. A user inserts the finger whose fingernail is desired to be printed into the printing-target insertion unit 158 and presses down the fingernail recognition button 903. Here, explanation is given on the assumption that printing for four fingers of the right hand is desired. By the fingernail recognition button 903 being pressed down, the image capturing unit 157 captures the hand that is inserted into the printing-target insertion unit 158 and displays the image capturing results in the captured image display area 902. Next, by the fingernail recognition button 903 being pressed down, the nail application recognizes the fingernail area in the captured image and displays the recognized results in the captured image display area 902 as a fingernail area 905. In a case where the fingernail recognition results are different form the desired results, a user selects the nail image data display area 913 of four fingers of the right hand after performing adjustment of the fingernail area. The adjustment of the fingernail area is to change at least one of the position, the size, and the orientation of the fingernail area by the user operation. In response to that the nail image data display area 913 of four fingers of the right hand is selected, the nail application displays a display frame 919 for explicitly indicating the nail image data selected by the user. Next, in a case where the printing button 904 is pressed down, a print job for performing printing for the fingernail area 905 at the respectively corresponding position based on the nail image data of each finger included in the selected nail image data display area 913. The print job created by the nail application is transmitted to the nail printer and the nail printer performs printing based on the transmitted print job. Here, for the nail image data included in the print job, the size, the shape and the like are determined based on the information on the fingernail area. It may also be possible for the nail application to perform display control processing to display the layout results in which the selected nail image data is arranged in the printing-target fingernail area 905 before generating the print job.

The display order may be another order. For example, it may also be possible for the nail application to transmit a camera activation job at the time of displaying the screen in FIG. 9 and start image capturing with the camera. Consequently, the image capturing results of the image capturing unit 157 may be displayed in the captured image display area 902 before the fingernail recognition button 903 is pressed down. Further, the nail application selects one of the nail image data display areas 911 to 914 as default nail image data. Then, in a case where the fingernail recognition button 903 is pressed down by a user, it may also be possible for the nail application to perform the display control processing to display the layout results in which each piece of the nail image data of the nail image data display area 913 selected as a default is arranged in the recognized fingernail area. Each piece of the nail image data is displayed based on the position and the size of the recognized fingernail area. Then, it may also be possible for the nail application to change at least one of the position, the size, and the orientation of the fingernail area in which each piece of the nail image data is displayed based on user instructions. The operation after the printing button 904 is pressed down is as described above.

### <Flow of Processing>

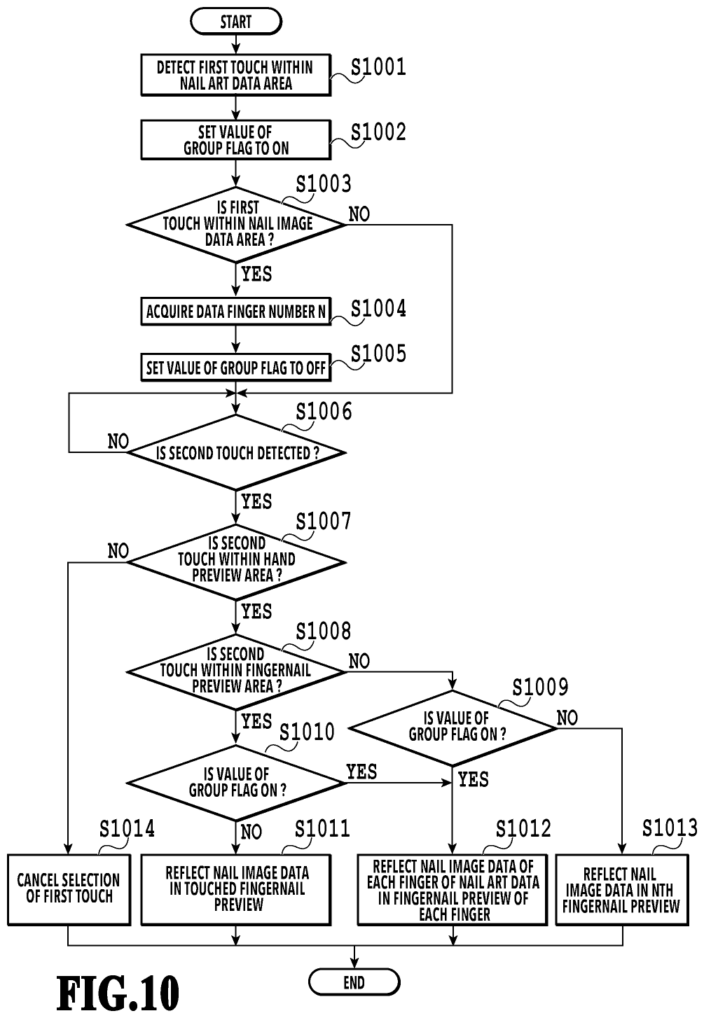

FIG. 10 is a flowchart of the series of processing shown in FIG. 3A to FIG. 5C in the present embodiment.

First, at step S1001, the CPU 103 detects a touch within the nail art data area by a user on the first GUI screen. The touch that is detected at this step is defined as a first touch. In the following, “step S-” is abbreviated to “S-”.

At S1002, the CPU 103 sets the value of a group flag to ON. The group flag is a flag indicating whether or not the touched area is the area of an image group. Here, it is assumed that the value is set to ON in a case where the touched area is an area regarded as an image group and the value is set to OFF in a case where the touched area is an area regarded as an individual image area.

At S1003, the CPU 103 determines whether the first touch that is the touch within the nail art data area is the touch within the nail image data area. In a case where the determination results at this step are affirmative, the processing advances to S1004 and on the other hand, in a case where the determination results are negative, the processing advances to S1006.

At S1004, the CPU 103 determines which finger whose nail image data is touched and acquires the number of the finger as a data finger number N. The finger number in this example is obtained by allocating 1 to the little finger of the left hand, 2 to the third finger of the left hand, and so on in this order, and therefore, the finger number of the thumb of the right hand is 6 and the finger number of the little finger of the right hand is 10. The allocation method of the finger number is not limited to the aspect such as this and it may also be possible to adopt an arbitrary method.

At S1005, the CPU 103 sets the value of the group flag to OFF. The reason is that the CPU 103 determines that a user has selected an individual finger upon receipt of the results at S1003.

At S1006, the CPU 103 determines whether a touch by a user on the first GUI screen has been detected. The touch that is detected at this step is defined as a second touch. In a case where the determination results at this step are affirmative, the processing advances to S1007 and on the other hand, in a case where the determination results are negative, the CPU 103 stands by until the second touch is detected.

At S1007, the CPU 103 determines whether the second touch detected at S1006 is the touch within the hand preview area. In a case where the determination results at this step are affirmative, the processing advances to S1008 and on the other hand, in a case where the determination results are negative, the processing advances to S1014.

At S1008, the CPU 103 determines whether the second touch is the touch within the fingernail preview area of one of the fingers. In a case where the determination results at this step are affirmative, the processing advances to S1010 and on the other hand, in a case where the determination results at this step are negative, the processing advances to S1009.

At S1009, the CPU 103 determines whether the value of the group flag is ON. In a case where the determination results at this step are affirmative, the processing advances to S1012 and on the other hand, in a case where the determination results at this step are negative, the processing advances to S1013.

At S1010, the CPU 103 determines whether the value of the group flag is ON. In a case where the determination results at this step are affirmative, the processing advances to S1012 and on the other hand, in a case where the determination results at this step are negative, the processing advances to S1011.

In a case where the value of the group flag is OFF, the nail image data of a single finger is selected by the first touch, and therefore, at S1011, the CPU 103 reflects the nail image data selected by the first touch in the fingernail preview area of the finger selected by the second touch.

In a case where YES is determined at S1009 or S1010, it is possible to regard that the entire nail art data has been selected by the first touch, not the nail image data of a single finger. Consequently, in this case, at S1012, the CPU 103 reflects the nail image data of each finger of the nail art data in the finger preview of each corresponding finger.

In a case where it is determined that the value of the group flag is not ON (that is, OFF) at S1009 (in a case of NO at S1009), the CPU 103 determines that the nail image data of a single finger has been selected by the first touch. Consequently, in this case, at S1013, the CPU 103 reflects the nail image data selected by the first touch in the fingernail preview of the finger corresponding to the finger number N acquired at S1004.

In a case where it is determined that the second touch is not the touch within the hand preview area at S1007 (in a case of NO at S1007), there is no area in which the nail art that is selected by the first touch is reflected, and therefore, the CPU 103 cancels the selection of the first touch at S1014.

In the aspect shown in FIG. 10, the finger number is acquired at S1004 and the nail image data that is reflected in the fingernail view is determined by using the finger number at S1013, but in a case where it is possible to specify the finger, the parameter may be not a number. For example, the parameter may be alphabet letters, such as A, B, and C, and the aspect thereof is not limited as long as it is possible to specify the finger.

As above, by the reflection processing in FIG. 10, it is possible to obtain the reflection results of which nail image data is reflected in which fingernail preview area. It is possible for the nail application to display the layout results in which the nail image data is arranged in the fingernail area on the screen in FIG. 9 by using the reflection results in FIG. 10 and the image obtained by capturing the fingernail that is the printing target.

According to the present embodiment, it is made possible for a user to reflect nail image data on a desired fingernail by an easy operation.

### Other Embodiments

In the present embodiment, explanation is given by taking the printer 151 in the aspect in which one hand is inserted into the printing-target insertion unit 158 as an example, but the printer is not limited to this. For example, the printer may be one in which both hands are inserted, such as one that is installed in a shop or the like. In this case, a person other than a user, for example, such as a shop assistant of the shop, may perform the operation.

Further, in each embodiment described previously, as the contents image, the nail image is adopted and as the reflection target thereof, the hand fingernail is adopted and as the reflection target group, the hand area is adopted, but the contents image and the reflection target in the present disclosure are not limited to those. For example, as the reflection target group, the foot area may be adopted and the processing of each embodiment may be used at the time of printing for the foot nail.

Further, the processing may be used for a purpose other than the nail printing and the processing of each embodiment described previously may be used at the time of laying out a certain image group for a plurality of layout targets.

Further, in each embodiment described previously, explanation is given mainly by taking an example in which an image (pattern) is printed as a nail art, but an aspect may be accepted in which a structure including a pattern is formed as a nail art by using shape data and image data representing a three-dimensional structure or the like.

Further, in each embodiment described previously, explanation is given by taking the aspect in which the hand is inserted into the printer 151 and printing is performed directly on the fingernail, but another aspect may be accepted. For example, the invention of each embodiment described previously may be applied to a case where printing is performed by using a printer that performs printing for an object that is attached to the fingernail, such as a seal.

Further, in each embodiment described previously, the image capturing unit 157 is included within the printer 151, but it may also be possible to perform image capturing by, for example, installing a camera-attached device, such as a smartphone, at the top of the printer 151. In that case, at the time of the fingernail recognition button 903 being pressed down, instructions to perform image capturing are given by communicating with the camera-attached device and the information processing apparatus 101 acquires the captured image and displays the captured image in the captured image display area 902. As long as it is possible for the information processing apparatus to acquire an image by performing communication, any device may be adopted and the device may be a camera, in addition to the camera-attached device, such as a smartphone.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to one embodiment of the present invention, it is possible to improve operability of a user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-102185, filed Jun. 12, 2020, which is hereby incorporated by reference wherein in its entirety.

What is claimed is:

1. A non-transitory computer-readable storage medium storing a program for causing a computer to operate as:
a display control unit configured to cause a display unit to display a graphical user interface having a first area for designating one contents image from among a plurality of contents images configuring a contents image group, a second area for designating one contents image group from among a plurality of contents image groups, a third area for designating an individual reflection target reflecting a contents image, and a fourth area for designating one reflection target group including a plurality of individual reflection targets; and
a reflection unit configured to, in a case where the first area and the third area are designated by a user, reflect a contents image corresponding to the first area in a reflection target corresponding to the third area and in a case where the second area and the fourth area are designated by a user, reflect each of a plurality of contents images configuring the contents image group corresponding to the second area in each of a plurality of individual reflection targets configuring a reflection target group corresponding to the fourth area in accordance with correspondence information indicating correspondence between each of the plurality of contents images and each of the plurality of individual reflection targets.

2. The storage medium according to claim 1, wherein
in a case where the first area is designated after the fourth area is designated, a contents image corresponding to the first area is reflected in a reflection target corresponding to the designated contents image in the reflection target group in accordance with the correspondence information.

3. The storage medium according to claim 1, wherein
in a case where the third area is designated after the second area is designated, a contents image corresponding to the third area in a contents image group corresponding to the second area is reflected in a reflection target in the designated third area.

4. The storage medium according to claim 1, wherein
in a case where a reflection target group is designated in the fourth area after a contents image is designated in the first area, the designated contents image is reflected in an individual reflection target that is included in the designated reflection target group and which corresponds to the contents image.

5. The storage medium according to claim 1, wherein
in a case where a contents image is designated in the first area after an individual reflection target is designated in the third area, the designated contents image is reflected in the designated individual reflection target.

6. The storage medium according to claim 1, wherein
in a case where a contents image group is designated in the second area after an individual reflection target is designated in the third area, each of a plurality of contents images included in the designated contents image group is reflected in an individual reflection target that is included in a reflection target group including the designated individual reflection target and which corresponds to each of the contents images.

7. The storage medium according to claim 1, wherein
the contents image is a nail image,
the individual reflection target is a fingernail area, and
the reflection target group is a hand area or a foot area.

8. The storage medium according to claim 1 for causing the computer to function as an instruction unit configured to give instructions to capture a printing target based on a user operation after reflection processing by the reflection unit is completed.

9. The storage medium according to claim 8 for causing the computer to function as a display control unit configured to cause the display unit to display layout results based on reflection results by the reflection unit and an image obtained by capturing the printing target.

10. A computer control method comprising:
a display control step of causing a display unit to display a graphical user interface having a first area for designating one contents image from among a plurality of contents images configuring a contents image group, a second area for designating one contents image group from among a plurality of contents image groups, a third area for designating an individual reflection target reflecting a contents image, and a fourth area for designating one reflection target group including a plurality of individual reflection targets; and
a reflection step of, in a case where the first area and the third area are designated by a user, reflecting a contents image corresponding to the first area in a reflection target corresponding to the third area and in a case where the second area and the fourth area are designated by a user, reflecting each of a plurality of contents images configuring the contents image group corresponding to the second area in each of a plurality of individual reflection targets configuring a reflection target group corresponding to the fourth area in accordance with correspondence information indicating correspondence between each of the plurality of contents images and each of the plurality of individual reflection targets.

11. An information processing apparatus comprising:
a display control unit configured to cause a display unit to display a graphical user interface having a first area for designating one contents image from among a plurality of contents images configuring a contents image group, a second area for designating one contents image group from among a plurality of contents image groups, a third area for designating an individual reflection target reflecting a contents image, and a fourth area for designating one reflection target group including a plurality of individual reflection targets; and
a reflection unit configured to, in a case where the first area and the third area are designated by a user, reflect a contents image corresponding to the first area in a reflection target corresponding to the third area and in a case where the second area and the fourth area are designated by a user, reflect each of a plurality of contents images configuring the contents image group corresponding to the second area in each of a plurality of individual reflection targets configuring a reflection target group corresponding to the fourth area in accordance with correspondence information indicating correspondence between each of the plurality of contents images and each of the plurality of individual reflection targets.

12. The information processing apparatus according to claim 11, wherein
in a case where the first area is designated after the fourth area is designated, a contents image corresponding to the first area is reflected in a reflection target corresponding to the designated contents image in the reflection target group in accordance with the correspondence information.

13. The information processing apparatus according to claim 11, wherein
in a case where the third area is designated after the second area is designated, a contents image corresponding to the third area in a contents image group corresponding to the second area is reflected in a reflection target in the designated third area.

14. The information processing apparatus according to claim 11, wherein
in a case where a reflection target group is designated in the fourth area after a contents image is designated in the first area, the designated contents image is reflected in an individual reflection target that is included in the designated reflection target group and which corresponds to the contents image.

15. The information processing apparatus according to claim 11, wherein
in a case where a contents image is designated in the first area after an individual reflection target is designated in the third area, the designated contents image is reflected in the designated individual reflection target.

16. The information processing apparatus according to claim 11, wherein
in a case where a contents image group is designated in the second area after an individual reflection target is designated in the third area, each of a plurality of contents images included in the designated contents image group is reflected in an individual reflection target that is included in a reflection target group including the designated individual reflection target and which corresponds to each of the contents images.

17. The information processing apparatus according to claim 11, wherein
the contents image is a nail image,
the individual reflection target is a fingernail area, and
the reflection target group is a hand area or a foot area.

18. The information processing apparatus according to claim 11 for causing the computer to function as an instruction unit configured to give instructions to capture a printing target based on a user operation after reflection processing by the reflection unit is completed.

19. The information processing apparatus according to claim 18 for causing the computer to function as a display control unit configured to cause the display unit to display layout results based on reflection results by the reflection unit and an image obtained by capturing the printing target.
